(19) United States
(12) Patent Application Publication
(10) Pub. No.: US 2020/0310981 A1
(43) Pub. Date: Oct. 1, 2020

(54) CONTROLLER, MEMORY SYSTEM AND OPERATING METHOD THEREOF

(71) Applicant: SK hynix Inc., Gyeonggi-do (KR)

(72) Inventor: Eu Joon BYUN, Gyeonggi-do (KR)

(21) Appl. No.: 16/670,508

(22) Filed: Oct. 31, 2019

(30) Foreign Application Priority Data
Mar. 27, 2019 (KR) 10-2019-0035205

(51) Int. Cl. G06F 12/1009; G06F 12/0875

(52) U.S. Cl. CPC G06F 12/1009; G06F 2212/657; G06F 2212/608; G06F 12/0875

(57) ABSTRACT

A memory system may include a nonvolatile memory device configured to store a plurality of L2P (Logical to Physical) map data, and a controller configured to control the nonvolatile memory device. The controller may include a memory configured to cache one or more of the plurality of L2P map data, and transfer L2P map data to a host, the L2P map data including the same logical address as the L2P map data cached in the memory among the plurality of L2P map data.

### CROSS-REFERENCES TO RELATED APPLICATION

The present application claims priority under 35 U.S.C. § 119(a) to Korean application number 10-2019-0035205, filed on Mar. 27, 2019, which is incorporated herein by reference in its entirety.

### BACKGROUND

### 1. Technical Field

Various embodiments generally relate to a semiconductor device, and more particularly, to a controller, a memory system and an operating method thereof.

### 2. Related Art

Recently, the paradigm for the computing environment has changed to a ubiquitous computing environment in which computer systems can be used anytime and anywhere. Therefore, the use of portable electronic devices such as a mobile phone, digital camera and notebook computer has rapidly increased. Such a portable electronic device generally uses a memory system using a memory device. The memory system is used to store data used in the portable electronic device.

Since the memory system using a memory device has no mechanical driver, the data storage device has excellent stability and durability, exhibits high information access speed, and has low power consumption. Examples of the memory system having such advantages include a universal serial bus (USB) memory device, a memory card having various interfaces, a universal flash storage (UFS) device, and a solid state drive (SSD).

### SUMMARY

Various embodiments are directed to a technique capable of improving the performance of a memory system which uses a memory resource of a host.

In an embodiment, a memory system may include a nonvolatile memory device configured to store plural pieces of Logical to Physical (L2P) map data, and a controller configured to control the nonvolatile memory device. The controller may comprise a memory configured to cache one or more of the plural pieces of L2P map data. The controller transfers L2P map data, which includes the same logical address as the L2P map data cached in the memory among the plural pieces of L2P map data, to a host.

In an embodiment, a controller may include a memory interface configured to receive plural pieces of L2P map data from a nonvolatile memory device, a memory configured to cache one or more pieces of the plural pieces of Logical to Physical (L2P) map data, a host interface configured to communicate with a host, and a processor configured to control the host interface to transfer L2P map data, which corresponds to the L2P map data cached in the memory among the plural pieces of L2P map data, to the host.

In an embodiment, there is provided an operating method of a data processing system including a host, a memory device and a controller for accessing the memory device based on one or more pieces of map data included in an access request from the host. The operating method may include storing, by the memory device, therein one or more pieces of map data; caching, by the controller, therein the one or more pieces of the map data stored in the memory device; caching, by the host, therein the one or more pieces of the map data cached in the controller; and updating, by the host, a piece within the map data cached in the host when a corresponding piece changes within the map data cached in the controller. The map data indicates a mapping relationship between a logical address and a physical address.

### BRIEF DESCRIPTION OF THE DRAWINGS

FIG. 1 is a diagram illustrating a configuration of a memory system in accordance with an embodiment.

FIG. 2 is a diagram describing an example in which the memory system in accordance with the embodiment uses a memory resource of a host.

FIG. 3 is a flowchart describing an operating method of a memory system in accordance with an embodiment.

FIG. 4 illustrates a diagram describing an operating method of a memory system in accordance with an embodiment.

FIG. 5 is a flowchart describing an operating method of a memory system in accordance with an embodiment.

FIG. 6 is a diagram illustrating a data processing system including a solid state drive (SSD) in accordance with an embodiment.

FIG. 7 is a diagram illustrating a configuration of a controller of FIG. 6.

FIG. 8 is a diagram illustrating a data processing system including a memory system in accordance with an embodiment.

FIG. 9 is a diagram illustrating a data processing system including a memory system in accordance with an embodiment.

FIG. 10 is a diagram illustrating a network system including a memory system in accordance with an embodiment.

FIG. 11 is a block diagram illustrating a nonvolatile memory device included in a memory system in accordance with an embodiment.

### DETAILED DESCRIPTION

The advantages and characteristics of the present disclosure and a method for achieving the advantages and characteristics will be described through the following embodiments with reference to the accompanying drawings. However, the present disclosure is not limited to the embodiments described herein, but may be embodied in different forms. The present embodiments are only provided to describe the present disclosure in detail, such that the technical idea of the present disclosure can be easily carried out by those skilled in the art to which the present disclosure pertains.

It is noted that reference to “an embodiment,” “another embodiment” or the like does not necessarily mean only one embodiment, and different references to any such phrase are not necessarily to the same embodiment(s).

As used herein, singular forms may include the plural forms as well and vice versa, unless the context clearly indicates otherwise. The articles ‘a’ and ‘an’ as used in this application and the appended claims should generally be construed to mean ‘one or more’ unless specified otherwise or clear from context to be directed to a singular form.

Throughout the specification, when a certain element is “coupled” to another element, it may not only indicate that the former element is “directly coupled to” the latter element, but also indicate that the former element is “indirectly coupled to” the latter element with another element interposed therebetween. In this specification, when an element “includes or comprises” a component, it may indicate that the element does not exclude another component unless referred to the contrary, but can further include or comprise another component.

Hereafter, embodiments will be described in detail with reference to the accompanying drawings.

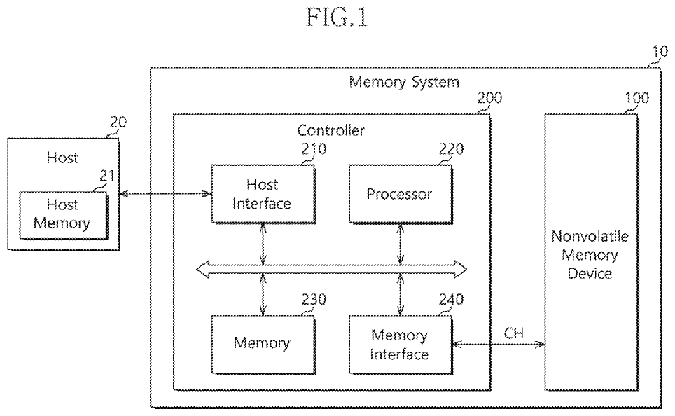

FIG. 1 is a diagram illustrating a configuration of a memory system 10 in accordance with an embodiment.

Referring to FIG. 1, the memory system 10 in accordance with the present embodiment may store data accessed by a host 20 such as a mobile phone, MP3 player, laptop computer, desktop computer, game machine, TV or in-vehicle infotainment system.

The memory system 10 may be fabricated as any one of various types of storage devices depending on an interface protocol coupled to the host 20. For example, the memory system 10 may be configured as any one of various types of storage devices which include an SSD (Solid State Drive), an MMC (Multi-Media Card) such as an eMMC, RS-MMC or micro-MMC, an SD (Secure Digital) card such as a mini-SD or micro-SD card, a USB (Universal Serial Bus) storage device, a UFS (Universal Flash Storage) device, a PCMCIA (Personal Computer Memory Card International Association) card-type storage device, a PCI (Peripheral Component Interconnection) card-type storage device, a PCI-E (PCI Express) card-type storage device, a CF (Compact Flash) card, a smart media card and a memory stick.

The memory system 10 may be fabricated as any one of various types of packages. For example, the memory system 10 may be fabricated as any one of various types of packages such as a POP (Package-On-Package), SIP (System-In-Package), SOC (System-On-Chip), MCP (Multi-Chip Package), COB (Chip-On-Board), WFP (Wafer-Level Fabricated Package) and WSP (Wafer-Level Stack Package).

The memory system 10 may include a nonvolatile memory device 100 and a controller 200.

The nonvolatile memory device 100 may operate as a storage medium of the memory system 10. The nonvolatile memory device 100 may be configured as any one of various types of nonvolatile memory devices such as a NAND flash memory device, NOR flash memory device, FRAM (Ferroelectric Random Access Memory) using a ferroelectric capacitor, MRAM (Magnetic Random Access Memory) using a TMR (Tunneling Magneto-Resistive) layer, PRAM (Phase Change Random Access Memory) using chalcogenide alloys, and ReRAM (Resistive Random Access Memory) using transition metal oxide, depending on memory cells.

FIG. 1 illustrates that the memory system 10 includes one nonvolatile memory device 100. However, this is only for convenience of description, and the memory system 10 may include a plurality of nonvolatile memory devices. The present embodiment may be applied in the same manner to the memory system 10 including a plurality of nonvolatile memory devices.

The nonvolatile memory device 100 may include a memory cell array (not illustrated) having a plurality of memory cells arranged at the respective intersections between a plurality of bit lines (not illustrated) and a plurality of word lines (not illustrated). The memory cell array may include a plurality of memory blocks, and each of the memory blocks may include a plurality of pages.

For example, each of the memory cells of the memory cell array may be configured as a single level cell (SLC) capable of storing 1-bit data or a multi-level cell (MLC) capable of storing 2 or more-bit data. The MLC may store 2-bit data, 3-bit data, 4-bit data or the like. In general, a memory cell for storing 2-bit data may be referred to as an MLC, a memory cell for storing 3-bit data may be referred to as a triple level cell (TLC), and a memory cell for storing 4-bit data may be referred to as a quad level cell (QLC). In the present embodiment, however, the memory cells for storing 2-bit to 4-bit data will be collectively referred to as MLCs, for convenience of description.

The memory cell array 110 may include one or more of the SLC and the MLC. Furthermore, the memory cell array 110 may include memory cells with a two-dimensional horizontal structure or memory cells with a three-dimensional vertical structure.

The controller 200 may include a host interface 210, a processor 220, a memory 230 and a memory interface 240. The controller 200 may control overall operations of the memory system 10 by driving firmware or software loaded to the memory 230. The controller 200 may decode and drive a code-based instruction or algorithm such as firmware or software. The controller 200 may be implemented in hardware or a combination of hardware and software. Although not illustrated in FIG. 1, the controller 200 may further include an error correction code (ECC) engine which generates parity data by performing ECC encoding on write data provided from the host, and performs ECC decoding on read data read from the nonvolatile memory device 100 using the parity data.

The host interface 210 may interface the host 20 and the memory system 10 in response to a protocol of the host 20. For example, the host interface 210 may communicate with the host 20 through any one protocol of USB (Universal Serial Bus), UFS (Universal Flash Storage), MMC (Multimedia Card), PATA (Parallel Advanced Technology Attachment), SATA (Serial Advanced Technology Attachment), SCSI (Small Computer System Interface), SAS (Serial Attached SCSI), PCI (Peripheral Component Interconnection) and PCI-E (PCI Express).

The processor 220 may include a micro control unit (MCU) and a central processing unit (CPU). The processor 220 may process a request transferred from the host 20. In order to process the request transferred from the host 20, the processor 220 may drive a code-based instruction or algorithm loaded to the memory 230, i.e. firmware, and control the nonvolatile memory device 100 and internal function blocks such as the host interface 210, the memory 230 and the memory interface 240.

The processor 220 may generate control signals to control an operation of the nonvolatile memory device 100 based on requests transferred from the host 20, and provide the generated control signals to the nonvolatile memory device 100 through the memory interface 240.

The memory 230 may include a random access memory (RAM) such as a dynamic RAM (DRAM) or static RAM (SRAM), and a read only memory (ROM). The memory 230 may store the firmware driven by the processor 220. Furthermore, the memory 230 may store data required for driving the firmware, for example, metadata. That is, the memory 230 may operate as a working memory. of the processor 220.

The memory 230 may include a data buffer for temporarily storing write data which are to be transferred from the host 20 to the nonvolatile memory device 100 or read data which are to be transferred from the nonvolatile memory device 100 to the host 20. That is, the memory 230 may operate as a buffer memory.

However, it is obvious to those skilled in the art that the memory 230 may include regions used for various purposes, such as a region used as a write data buffer for temporarily storing write data, a region used as a read data buffer for temporarily storing read data, and a region used as a map cache buffer for caching map data.

The memory 230 may store system data or meta data.

When the nonvolatile memory device 100 is configured as a flash memory device, the processor 220 may control a unique operation of the nonvolatile memory device 100, and drive software referred to as a flash translation layer (FTL) in order to provide device compatibility to the host 20. As the FTL is driven, the host 20 may recognize and use the memory system 10 as a general storage device such as a hard disk.

The memory interface 240 may control the nonvolatile memory device 100 under control of the processor 220. The memory interface 240 may also be referred to as a memory controller. The memory interface 240 may provide control signals to the nonvolatile memory device 100. The control signals may include a command, address and operation control signal for controlling the nonvolatile memory device 100. The memory interface 240 may provide data stored in the data buffer to the nonvolatile memory device 100 or store data transferred from the nonvolatile memory device 100 in the data buffer.

The controller 200 may include a first memory (not illustrated) which is directly coupled to the processor 220. The processor 220 may load firmware from the memory 230 to the first memory, and drive the firmware loaded in the first memory. The first memory may be present outside the controller 200.

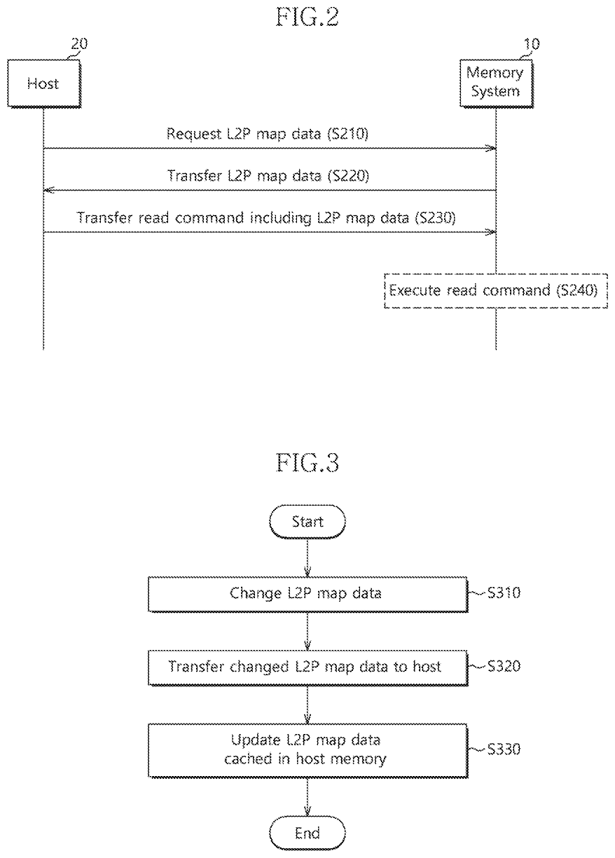

FIG. 2 is a diagram illustrating that the memory system in accordance with the embodiment uses a memory resource of the host.

Referring to FIG. 2, the host 20 may request all or some of plural pieces of Logical to Physical (L2P) map data stored in the memory system 10 from the memory system 10, in step S210.

In an embodiment, when a booting operation of the memory system 10 is completed, the host 20 may request the L2P map data from the memory system 10. The L2P map data may indicate a mapping relationship between a logical address used by the host 20 and a physical address used by the controller 200, in order to access data stored in the nonvolatile memory device 100. The logical address may include a logical page number LPN set on a page basis and a logical block address LBA. The physical address may include a physical page number PPN set on a page basis and a physical block address PBN.

In an embodiment, the host 20 may request L2P map data corresponding to a specific workload among plural pieces of L2P map data stored in the memory system 10.

In an embodiment, the host 20 may request all or some of plural pieces of L2P map data stored in the nonvolatile memory device 100 from the memory system 10.

In an embodiment, the host 20 may request all or some of plural pieces of L2P map data stored in the memory 230 of the controller 200 from the memory system 10.

In step S220, the memory system 10 may transfer one or more pieces of L2P map data requested by the host 20 to the host 20.

In an embodiment, the memory 230 of the controller 200 may include a DRAM configured to store plural pieces of L2P map data received from the nonvolatile memory device 100 and an SRAM configured to cache one or more of the plural pieces of L2P map data stored in the DRAM.

In an embodiment, the memory system 10 may transfer all or some of the plural pieces of L2P map data stored in the memory 230 of the controller 200 to the host 20.

In an embodiment, the memory system 10 may read all or some of the plural pieces of L2P map data stored in the nonvolatile memory device 100, and transfer the read L2P map data to the host 20.

The host 20 may receive one or more pieces of L2P map data from the memory system 10, and cache the received pieces of L2P map data into the host memory 21.

In step S230, when the host 20 needs data stored in the memory system 10, the host 20 may generate a read command including L2P map data selected from the L2P map data cached in the host memory 21. The selected L2P map data may indicate a location of target data of the read command within the nonvolatile memory device 100. The host 20 may transfer the generated read command to the memory system 10.

In step S240, the memory system 10 may receive the read command from the host 20 and perform a read operation of reading the data stored in the nonvolatile memory device 100 according to the received read command.

In an embodiment, the memory system 10 may read the data stored in the nonvolatile memory device 100 based on the L2P map data included in the read command.

In an embodiment, the memory system 10 may read the data based on the L2P map data cached in the memory 230, without using the L2P map data included in the read command.

That is, the memory system 10 may cache the L2P map data into the host memory 21 having a relatively large capacity, and execute the read command including L2P map data selected from the L2P map data cached in the host memory 21, thereby securing storage space of the memory 230 for caching the L2P map data. Furthermore, the memory system 10 does not need to refer to the L2P map data cached in the memory system 10 when executing the read command, which improves the performance of the memory system 10.

FIG. 2 has been described with the L2P map data taken as an example. However, the L2P map data may be cached into the host memory 21 in units of L2P segments each including plural pieces of L2P map data.

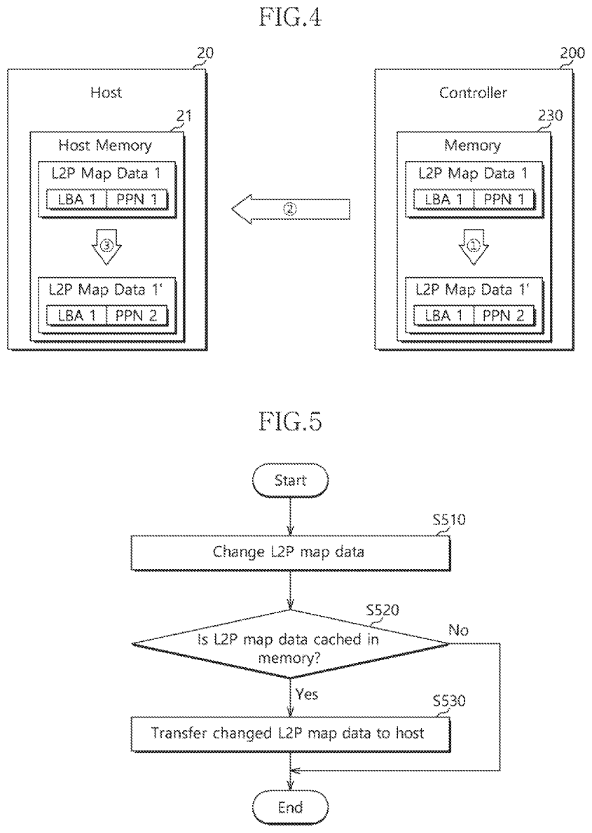

FIG. 3 is a flowchart for describing an operating method of a memory system in accordance with an embodiment. FIG. 4 illustrates a diagram describing an operating method of a memory system in accordance with an embodiment.

The following descriptions will be based on an example in which L2P map data 1 is cached in the host memory 21 according to the process of FIG. 2.

Referring to FIGS. 3 and 4, the memory system 10 may change the L2P map data 1 in step S310. Specifically, the controller 200 may perform an operation, due to which a map data change event occurs, such as garbage collection, read reclaim or data update, and store data, originally stored in a location indicated by a physical page number PPN1, into a location indicated by a physical page number PPN2. At this time, as illustrated in FIG. 4, the mapping relationship of the L2P map data 1 may be changed such that the physical page number PPN1 originally mapped to a logical block address LBA1 of the L2P map data 1 is changed to the physical page number PPN2 (\textcircled{1}). In this case, since the logical block address LBA1 of the L2P map data 1 cached in the host memory 21 still maintains the original a mapping relationship between the logical block address LBA1 and the physical page number PPN1, the controller 200 needs to perform a sync-up operation to perform synchronization with the changed L2P map data 1.

In an embodiment, the memory system 10 may inform the host 20 of the change of the L2P map data 1.

In an embodiment, the host 20 may provide the memory system 10 with a sync-up request for the L2P map data 1 cached in the host memory 21.

In an embodiment, when informed of the change to the L2P map data 1 by the memory system 10, the host 20 may transfer a sync-up request to the memory system 10.

In step S320, when the sync-up request is received from the host 20, the memory system 10 may transfer the changed L2P map data 1 to the host 20. That is, as illustrated in FIG. 4, the controller 200 may transfer the L2P map data 1 stored in the memory 230 to the host 20 (\textcircled{2}).

In step S330, the host 20 may receive the changed L2P map data 1 from the controller 200. The host 20 may update the L2P map data 1 cached in the host memory 21 based on the changed L2P map data 1 (\textcircled{3}). That is, the mapping relationship may be changed such that the physical page number PPN1 originally mapped to the logical block address LBA1 within the L2P map data 1 cached in the host memory 21 is changed to the physical page number PPN2.

FIGS. 3 and 4 have been described with the L2P map data taken as an example. However, the L2P map data may be cached into the host memory in units of L2P segments each including plural pieces of L2P map data.

FIG. 5 is a flowchart describing an operation of the memory system in accordance with the present embodiment.

The following descriptions will be based on that L2P map data is cached in the host memory 21 according to the process of FIG. 2.

In step S510, the memory system 10 may change the L2P map data. Specifically, the controller 200 may perform a map data change event, due to which a physical address mapped to the logical address of the L2P map data is changed. The map data change event may include a garbage collection operation, a read reclaim operation, and an update operation for data stored in a user data region of the nonvolatile memory device 100.

In step S520, the memory system 10 may determine whether the changed L2P map data is cached in the memory 230 of the controller 200. Specifically, the controller 200 may determine whether L2P map data is cached in the memory 230, the L2P map data having the same logical address as the changed L2P map data at step S520. Step S520 may allow a sync-up operation to be performed only on the L2P map data cached in the memory 230 of the controller 200, thereby preventing degradation in performance of the memory system 10 due to frequent sync-up operations.

In step S530, the memory system 10 may transfer the changed L2P map data, which is cached in the memory 230, to the host 20. Specifically, when the changed L2P map data is cached in the memory 230 (that is, “Yes” at step S520), the controller 200 may transfer the changed L2P map data, which is cached in the memory 230, to the host 20. At this time, the host 20 may update the L2P map data including the same logical address as the transferred (i.e., changed) L2P map data among the L2P map data cached in the host memory 21.

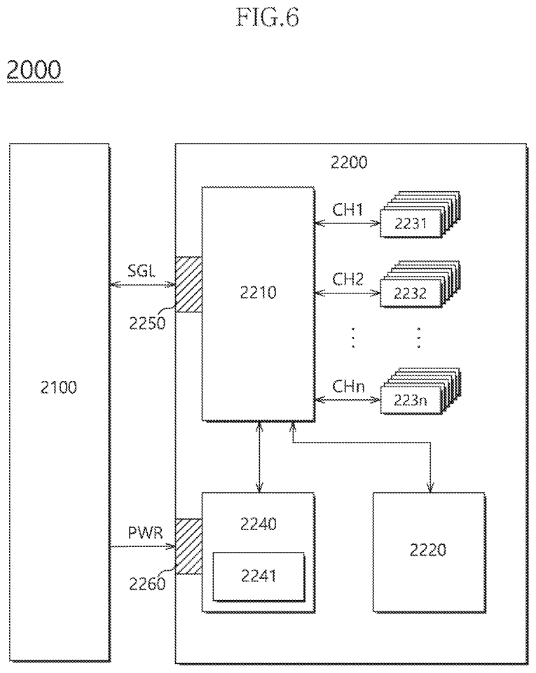

FIG. 6 is a diagram illustrating a data processing system including a solid state drive (SSD) in accordance with an embodiment. Referring to FIG. 6, the data processing system 2000 may include a host 2100 and an SSD 2200.

The SSD 2200 may include a controller 2210, a buffer memory device 2220, nonvolatile memory devices 2231 to 223n, a power supply 2240, a signal connector 2250 and a power connector 2260.

The controller 2210 may control overall operations of the SSD 2200.

The buffer memory device 2220 may temporarily store data to be stored in the nonvolatile memory devices 2231 to 223n. Furthermore, the buffer memory device 2220 may temporarily store data read from the nonvolatile memory devices 2231 to 223n. The data temporarily stored in the buffer memory device 2220 may be transferred to the host 2100 or the nonvolatile memory devices 2231 to 223n under control of the controller 2210.

The nonvolatile memory devices 2231 to 223n may be used as storage media of the SSD 2200. The nonvolatile memory devices 2231 to 223n may be coupled to the controller 2210 through a plurality of channels CH1 to CH, respectively. One or more nonvolatile memory devices may be coupled to one channel. The nonvolatile memory devices coupled to one channel may be coupled to the same signal bus and the same data bus.

The power supply 2240 may provide power PWR inputted through the power connector 2260 into the SSD 2200. The power supply 2240 may include an auxiliary power supply 2241. The auxiliary power supply 2241 may supply power to normally turn off the SSD 2200, when a sudden power off occurs. The auxiliary power supply 2241 may include large capacitors capable of storing power PWR.

The controller 2210 may exchange signals SGL with the host 2100 through the signal connector 2250. The signals SGL may include a command, address, data and the like. The signal connector 2250 may be configured as various types of connectors depending on an interface method between the host 2100 and the SSD 2200.

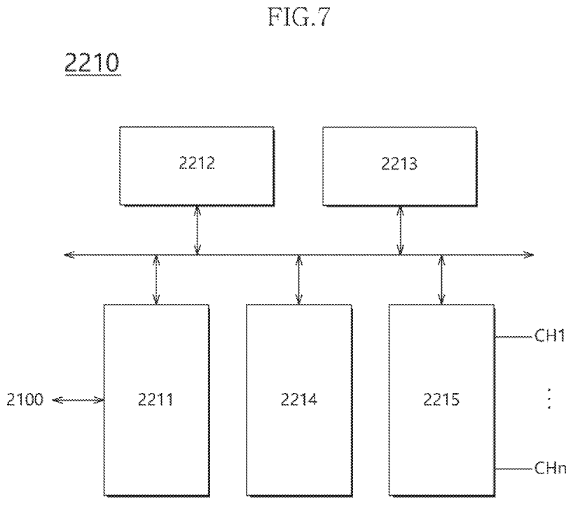

FIG. 7 illustrates a configuration of the controller of FIG. 6. Referring to FIG. 7, the controller 2210 may include a host interface 2211, a control unit 2212, a RAM 2213, an ECC unit 2214 and a memory interface 2215.

The host interface 2211 may interface the host 2100 and the SSD 2200 according to a protocol of the host 2100. For example, the host interface 2211 may communicate with the host 2100 through any one protocol of secure digital, USB (Universal Serial Bus), MMC (Multi-Media Card), eMMC (Embedded MMC), PCMCIA (Personal Computer Memory Card International Association), PATA (Parallel Advanced Technology Attachment), SATA (Serial Advanced Technology Attachment), SCSI (Small Computer System Interface), SAS (Serial Attached SCSI), PCI (Peripheral Component Interconnection), PCI-E (PCI Express) and UFS (Universal Flash Storage). The host interface 2211 may perform a disk emulation function of supporting the host 2100 to recognize the SSD 2200 as a universal memory system, for example, a hard disk drive (HDD).

The control unit 2212 may analyze and process the signal SGL inputted from the host 2100. The control unit 2212 may control operations of internal function blocks according to firmware or software for driving the SSD 2200. The RAM 2213 may be used as a working memory for driving such firmware or software.

The ECC unit 2214 may generate parity data of the data which are to be transferred to the nonvolatile memory devices 2231 to 223n. The generated parity data and the data may be stored in the nonvolatile memory devices 2231 to 223n, The ECC unit 2214 may detect an error of data read from the nonvolatile memory devices 2231 to 223n based on the parity data. When the detected error falls within a correctable range, the ECC unit 2214 may correct the detected error.

The memory interface 2215 may provide a control signal such as a command and address to the nonvolatile memory devices 2231 to 223n, under control of the control unit 2212. The memory interface 2215 may exchange data with the nonvolatile memory devices 2231 to 223n, under control of the control unit 2212. For example, the memory interface 2215 may provide the nonvolatile memory devices 2231 to 223n with data stored in the buffer memory device 2220, or provide the buffer memory device 2220 with data read from the nonvolatile memory devices 2231 to 223n.

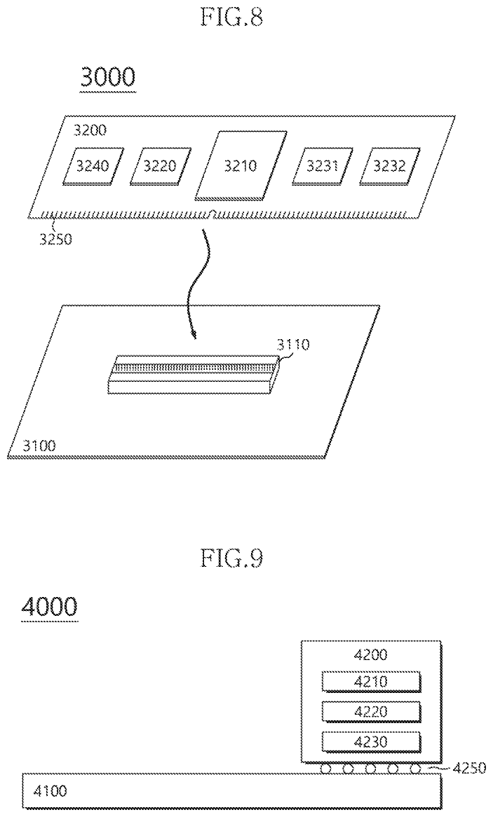

FIG. 8 is a diagram illustrating a data processing system including a memory system in accordance with an embodiment. Referring to FIG. 8, the data processing system 3000 may include a host 3100 and a memory system 3200.

The host 3100 may be configured in the form of a board such as a printed circuit board (PCB). Although not illustrated, the host 3100 may include internal function blocks for performing a function of the host.

The host 3100 may include a connection terminal 3110 such as a socket, slot or connector. The memory system 3200 may be mounted on the connection terminal 3110.

The memory system 3200 may be configured in the form of a board such as a PCB. The memory system 3200 may be referred to as a memory module or memory card. The memory system 3200 may include a controller 3210, a buffer memory device 3220, nonvolatile memory devices 3231 and 3232, a power management integrated circuit (PMIC) 3240 and a connection terminal 3250.

The controller 3210 may control overall operations of the memory system 3200. The controller 3210 may be configured in the same manner as the controller 2210 illustrated in FIG. 7.

The buffer memory device 3220 may temporarily store data which are to be stored in the nonvolatile memory devices 3231 and 3232. Furthermore, the buffer memory device 3220 may temporarily store data read from the nonvolatile memory devices 3231 and 3232. The data which are temporarily stored in the buffer memory device 3220 may be transferred to the host 3100 or the nonvolatile memory devices 3231 and 3232 under control of the controller 3210.

The nonvolatile memory devices 3231 and 3232 may be used as storage media of the memory system 3200.

The PMIC 3240 may provide power inputted through the connection terminal 3250 into the memory system 3200. The PMIC 3240 may manage power of the memory system 3200 under control of the controller 3210.

The connection terminal 3250 may be coupled to the connection terminal 3110 of the host. Through the connection terminal 3250, signals and power may be transferred between the host 3100 and the memory system 3200, the signals including a command, address, data and the like. The connection terminal 3250 may be configured in various manners depending on an interface method between the host 3100 and the memory system 3200. The connection terminal 3250 may be disposed at any one side of the memory system 3200.

FIG. 9 is a diagram illustrating a data processing system including a memory system in accordance with an embodiment. Referring to FIG. 9, the data processing system 4000 may include a host 4100 and a memory system 4200.

The host 4100 may be configured in the form of a board such as a PCB. Although not illustrated, the host 4100 may include internal function blocks for performing a function of the host.

The memory system 4200 may be configured as a surface mount package. The memory system 4200 may be mounted on the host 4100 through solder balls 4250. The memory system 4200 may include a controller 4210, a buffer memory device 4220 and a nonvolatile memory device 4230.

The controller 4210 may control overall operations of the memory system 4200. The controller 4210 may be configured in the same manner as the controller 2210 illustrated in FIG. 7.

The buffer memory device 4220 may temporarily store data which are to be stored in the nonvolatile memory device 4230. Furthermore, the buffer memory device 4220 may temporarily store data read from the nonvolatile memory device 4230. The data which are temporarily stored in the buffer memory device 4220 may be transferred to the host 4100 or the nonvolatile memory device 4230 under control of the controller 4210.

The nonvolatile memory device 4230 may be used as a storage medium of the memory system 4200.

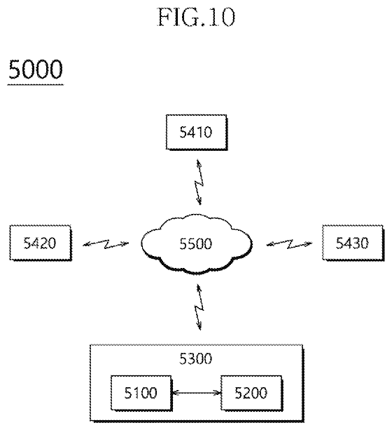

FIG. 10 is a diagram illustrating a network system 500 including a memory system in accordance with an embodiment. Referring to FIG. 10, the network system 5000 may include a server system 5300 and a plurality of client systems 5410 to 5430 which are connected through a network 5500.

The server system 5300 may serve data in response to requests of the plurality of client systems 5410 to 5430. For example, the server system 5300 may store data provided from the plurality of client systems 5410 to 5430. For another example, the server system 5300 may provide data to the plurality of client systems 5410 to 5430.

The server system 5300 may include a host 5100 and a memory system 5200. The memory system 5200 may be configured as the memory system 10 of FIG. 1, the SSD 2200 of FIG. 7, the memory system 3200 of FIG. 8 or the memory system 4200 of FIG. 9.

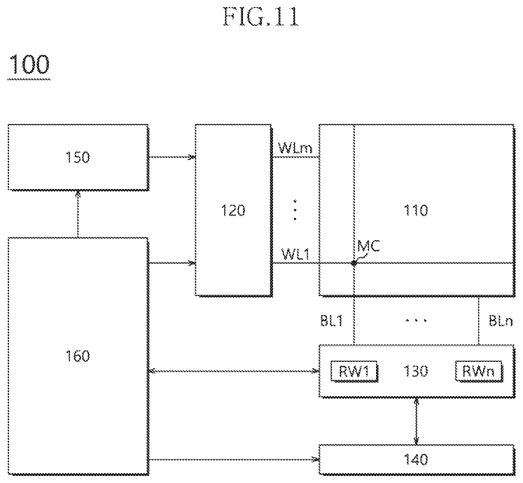

FIG. 11 is a block diagram illustrating a nonvolatile memory device included in a memory system in accordance with an embodiment. Referring to FIG. 11, the nonvolatile memory device 100 may include a memory cell array 110, a row decoder 120, a column decoder 130, a data read/write block 140, a voltage generator 150 and a control logic 160.

The memory cell array 110 may include memory cells MC arranged at the respective intersections between word lines WL1 to WLm and bit lines BL1 to BLn.

The row decoder 120 may be coupled to the memory cell array 110 through the word lines WL1 to WLm. The row decoder 120 may operate under control of the control logic 160. The row decoder 120 may decode an address provided from an external device (not illustrated). The row decoder 120 may select and drive the word lines WL1 to WLm based on the decoding result. For example, the row decoder 120 may provide word line voltages received from the voltage generator 150 to the word lines WL1 to WLm.

The data read/write block 140 may be coupled to the memory cell array 110 through the bit lines BL1 to BLn. The data read/write block 140 may include read/write circuits RW1 to RWn corresponding to the respective bit lines BL1 to BLn. The data read/write block 140 may operate under control of the control logic 160. The data read/write block 140 may operate as a write driver or sense amplifier depending on operation modes. For example, the data read/write block 140 may operate as a write driver which stores data provided from the external device in the memory cell array 110, during a write operation. For another example, the data read/write block 140 may operate as a sense amplifier which reads data from the memory cell array 110, during a read operation.

The column decoder 130 may operate under control of the control logic 160. The column decoder 130 may decode an address provided from the external device. The column decoder 130 may couple the read/write circuits RW1 to RWn of the data read/write block 140, corresponding to the respective bit lines BL1 to BLn, to a data input/output line (or data input/output buffer) based on the decoding result.

The voltage generator 150 may generate voltages to be used for an internal operation of the nonvolatile memory device 100. The voltages generated by the voltage generator 150 may be applied to the memory cells of the memory cell array 110. For example, a program voltage generated during a program operation may be applied to a word line of memory cells on which the program operation is to be performed. For another example, an erase voltage generated during an erase operation may be applied to well regions of memory cells on which the erase operation is to be performed. For another example, a read voltage generated during a read operation may be applied to a word line of memory cells on which the read operation is to be performed.

The control logic 160 may control overall operations of the nonvolatile memory device 100 based on a control signal provided from the external device. For example, the control logic 160 may control an operation of the nonvolatile memory device 100, such as a read, write or erase operation of the nonvolatile memory device 100.

In accordance with the present embodiments, the performance of the memory system can be improved through an efficient sync-up operation.

While various embodiments have been described above, it will be understood to those skilled in the art that the embodiments described are examples only. Accordingly, the memory system and the operating method thereof, which have been described herein, should not be limited based on the described embodiments.

Embodiments of the present disclosure have been described with reference to the accompanying drawings, and specific terms or words used in the description should be construed in accordance with the spirit of the present disclosure without limiting the subject matter thereof. It should be understood that many variations and modifications of the basic inventive concept described herein will still fall within the spirit and scope of the present disclosure as defined in the appended claims and their equivalents.

What is claimed is:

1. A memory system comprising:
a nonvolatile memory device configured to store plural pieces of Logical to Physical (L2P) map data; and
a controller configured to control the nonvolatile memory device,
wherein the controller comprises a memory configured to cache one or more of the plural pieces of L2P map data, and
wherein the controller transfers L2P map data, which includes the same logical address as the L2P map data cached in the memory among the plural pieces of L2P map data, to a host.

2. The memory system according to claim 1, wherein the controller does not transfer L2P map data, which are not the same as the L2P map data cached in the memory among the plural pieces of L2P map data, to the host.

3. The memory system according to claim 1, wherein the controller transfers, when an L2P map data request is received from the host, to the host the L2P map data including the same logical address as the L2P map data cached in the memory among the plural pieces of L2P map data.

4. The memory system according to claim 1, wherein the memory comprises:
a first memory configured to store plural pieces of L2P map data read from the nonvolatile memory device; and
a second memory configured to cache one or more pieces within the L2P map data stored in the first memory,
wherein the memory transfers L2P map data, which includes the same logical address as the L2P map data stored in the first memory among the L2P map data cached in the second memory, to the host.

5. The memory system according to claim 4, wherein the first memory is a dynamic random access memory (DRAM), and the second memory is a static random access memory (SRAM).

6. The memory system according to claim 1, wherein the controller transfers to the host the L2P map data including the same logical address as the L2P map data cached in the memory and changed due to a map data change event among the plural pieces of L2P map data.

7. The memory system according to claim 6, wherein the map data change event is an event that a physical address mapped to the same logical address as the L2P map data cached in the memory is changed.

8. The memory system according to claim 6, wherein the map data change event is at least one of update, garbage collection, and read reclaim operations.

9. The memory system according to claim 6, wherein the controller informs the host of the map data change event; and then transfers the L2P map data, which includes the same logical address as the L2P map data cached in the memory among the plural pieces of L2P map data, to the host when the changed L2P map data is requested by the host.

10. A controller comprising:
a memory interface configured to receive plural pieces of L2P map data from a nonvolatile memory device;
a memory configured to cache one or more pieces of the plural pieces of Logical to Physical (L2P) map data;
a host interface configured to communicate with a host; and
a processor configured to control the host interface to transfer L2P map data, which corresponds to the L2P map data cached in the memory among the plural pieces of L2P map data, to the host.

11. The controller according to claim 10, wherein the processor controls the host interface not to transfer L2P map data, which are not the same as the L2P map data cached in the memory among the plural pieces of L2P map data, to the host.

12. The controller according to claim 10, wherein the processor controls, when an L2P map data request is received from the host, the host interface to transfer L2P map data, which includes the same logical address as the L2P map data cached in the memory among the plural pieces of L2P map data, to the host.

13. The controller according to claim 10, wherein the memory comprises:
a first memory configured to store plural pieces of L2P map data read from the nonvolatile memory device; and
a second memory configured to cache one or more pieces within the plural pieces of L2P map data stored in the first memory,
wherein the processor controls the host interface to transfer L2P map data, which includes the same logical address as the L2P map data stored in the first memory among the L2P map data cached in the second memory, to the host.

14. The controller according to claim 10, wherein the first memory is a dynamic random access memory (DRAM), and the second memory is a static random access memory (SRAM).

15. The controller according to claim 10, wherein the processor controls the host interface to transfer to the host the L2P map data including the same logical address as the L2P map data cached in the memory and changed due to a map data change event among the plural pieces of L2P map data.

16. The controller according to claim 15, wherein the map data change event indicates that a physical address mapped to a logical address is changed.

17. The controller according to claim 15, wherein the map data change event is at least one of update, garbage collection, and read reclaim operations.

18. The controller according to claim 15, wherein the processor controls the host interface to inform the host of the map data change event, and then transfers the L2P map data, which includes the same logical address as the L2P map data cached in the memory among the plural pieces of L2P map data, to the host when the changed L2P map data is requested by the host.

19. An operating method of a data processing system including a host, a memory device and a controller for accessing the memory device based on one or more pieces of map data included in an access request from the host, the operating method comprising:
storing, by the memory device, therein one or more pieces of map data;
caching, by the controller, therein the one or more pieces of the map data stored in the memory device;
caching, by the host, therein the one or more pieces of the map data cached in the controller; and
updating, by the host, a piece within the map data cached in the host when a corresponding piece changes within the map data cached in the controller,
wherein the map data indicates a mapping relationship between a logical address and a physical address, and
wherein one or more pieces within the map data cached in the host are to be included in the access request.
